(19) United States
(12) Patent Application Publication
(10) Pub. No.: US 2021/0140201 A1
(43) Pub. Date: May 13, 2021

(54) CROSS BAR TYPE UNIVERSAL LOCK-DRIVING STRUCTURE

(71) Applicant: Shanghai MingWei Hardware Co., Ltd., Shanghai (CN)

(72) Inventor: Lawrence CHEN, Shanghai (CN)

(21) Appl. No.: 16/738,574

(22) Filed: Jan. 9, 2020

(30) Foreign Application Priority Data
Nov. 12, 2019 (TW) 108214988

(51) Int. Cl. E05B 65/10

(52) U.S. Cl. CPC E05B 65/1066; E05Y 2900/134

(57) ABSTRACT

A cross bar type universal lock-driving structure to be mounted in a panel-outside space of a door panel has a horizontal channel and a vertical channel for being universally assembled to one of a single-point lock, a double-point lock, a three-point lock, a vertical single-point lock, an embedded lock cartridge and an embedded vertical double-point lock-driving structure. The cross bar type universal lock-driving structure includes a handle-end base, a cross bar type handle assembly and a driving member. The handle-end base, deposed in the panel-outside space of the door panel, is furnished with a through hole. The cross bar type handle assembly is pivotally connected with the handle-end base. The driving member, connected fixedly with the cross bar type handle assembly, is to contact a driven unit of one of the single-point lock, the double-point lock, the three-point lock, the vertical single-point lock, the embedded lock cartridge and the embedded vertical double-point lock-driving structure, and drives the driven unit.

This application claims the benefit of Taiwan Patent Application Serial No.108214988, filed on Nov. 12, 2019, the subject matter of which is incorporated herein by reference.

### BACKGROUND OF THE INVENTION

### (1) Field of the Invention

The invention relates to a lock structure, and more particularly to a cross bar type universal lock-driving structure.

### (2) Description of the Prior Art

Generally speaking, a building is typically furnished with several fire doors. While in meeting a fire, people can unlock the nearby fire door, and escape therefrom. Currently, locks for the fire door can be classified, according to the installation pattern, into single-point locks, double-point locks, three-point locks, vertical single-point locks, embedded lock cartridges and embedded vertical double-point lock-driving structures. In particular, the embedded lock cartridge is mounted inside the fire door, and, according to different protrusion types of bolts, further classified into a horizontal type or a rotational type. In addition, the embedded vertical double-point lock-driving structure is also mounted inside the fire door, but is furnished with a lock bar moving vertically. On the other hand, the single-point lock, the double-point lock, the three-point lock and the vertical single-point lock are all mounted exterior to the fire door.

Nevertheless, respective to different lock cartridges or locks, different lock-driving structures shall be utilized to control the corresponding lock cartridges or locks. Refer now to FIG. 1 and FIG. 2; where FIG. 1 is a schematic view of a conventional lock-driving structure installed at a fire door, and FIG. 2 shows schematically another conventional lock-driving structure installed at the fire door. As shown, different lock-driving structures PA1 and PA1 a are mounted to the corresponding fire doors PA2.

In FIG. 1, the lock-driving structure PA1 includes a handle assembly PA11 and a handle-end base PA12. The handle-end base PA12 is furnished for a bolt PA3 of the single-point lock to mount in a penetration manner. As the handle assembly PA11 is depressed down, the bolt PA3 would be driven horizontally so as to unlock and thus open the fire door PA2. In FIG. 2, the lock-driving structure PA1a includes a handle assembly PA11 and a handle-end base PA12a. The handle-end base PA12a is furnished for a lock bar PA3a of the double-point lock to mount in a vertical penetration manner. As the handle assembly PA11 is depressed down, the lock bar PA3a would be driven to move vertically so as to unlock and thus open the fire door PA2.

However, either the lock-driving structure PA1 or the lock-driving structure PA1a is structurally unique. Namely, as shown, the lock-driving structure PA1a cannot apply the bolt PA3 that should be horizontally mounted, while the lock-driving structure PA1 cannot apply the lock bar PA3a that should be vertically mounted. In other words, different locks should be paired by specific lock-driving structures, and thereby the relative manufacturing cost would be expensive. Further, replacement and maintenance of these conventional locks and lock cartridges are extremely tedious, and thus development for an improvement of the lock-driving structure is definitely needed.

### SUMMARY OF THE INVENTION

In view that different conventional locks should be paired by specific lock-driving structures, thus problems in expensive manufacturing cost and tedious replacement process would be inevitable. Accordingly, it is an object of the present invention to provide a cross bar type universal lock-driving structure that can be useful for resolving at least one of the aforesaid two problems.

In this disclosure, the cross bar type universal lock-driving structure to be mounted in a panel-outside space of a door panel has a horizontal channel and a vertical channel for being universally assembled to at least one of a single-point lock, a double-point lock, a three-point lock, a vertical single-point lock, an embedded lock cartridge and an embedded vertical double-point lock-driving structure. The cross bar type universal lock-driving structure includes a handle-end base, a cross bar type handle assembly and a driving member.

The handle-end base, deposed in the panel-outside space of the door panel, is furnished with a through hole. The cross bar type handle assembly is pivotally connected with the handle-end base. The driving member, connected fixedly with the cross bar type handle assembly, is to contact a driven unit of one of the single-point lock, the double-point lock, the three-point lock, the vertical single-point lock, the embedded lock cartridge and the embedded vertical double-point lock-driving structure, and drives the driven unit while the cross bar type handle assembly is depressed downward.

The horizontal channel allows at least a part of the driven unit of the single-point lock to move thereinside, the vertical channel allows at least another part of the driven unit of one of the double-point lock, the three-point lock and the vertical single-point lock to move thereinside, and the through hole allows at least a further part of the driven unit of one of the embedded lock cartridge and the embedded vertical double-point lock-driving structure to move therethrough.

In one embodiment of the present invention, the driving member is integrated with the cross bar type handle assembly as a unique piece.

In one embodiment of the present invention, the cross bar type handle assembly includes a handle and a connection bar. The handle, disposed pivotally to the handle-end base, is connected with the driving member. The connection bar is connected with the handle.

In one embodiment of the present invention, the cross bar type handle assembly further includes a handle seat, the handle seat is connected with the handle-end base, and the handle seat is used for the handle to penetrate through so as to have the handle to be pivotally connected with the handle-end base.

In one embodiment of the present invention, the handle-end base includes a basic frame and a mounting frame. The basic frame, mounted onto the door panel, is furnished with the through hole. The mounting frame, disposed at a side of the basic frame by opposing the door panel, has the horizontal channel and the vertical channel.

In one embodiment of the present invention, the mounting frame is further furnished with a base through hole for the driving member to penetrate through.

In one embodiment of the present invention, the through hole is a rectangular hole.

In one embodiment of the present invention, the through hole is a rectangular hole.

As stated above, the cross bar type universal lock-driving structure of this invention can be directly and commonly used to fit different locks and lock cartridges. Thereupon, the relative manufacturing cost can be significantly reduced. In addition, while a replacement or maintenance of the lock is needed, the replacement process and complexity would be remarkably reduced due to the universality provided by the cross bar type universal lock-driving structure of this invention.

All these objects are achieved by the cross bar type universal lock-driving structure described below.

### BRIEF DESCRIPTION OF THE DRAWINGS

The present invention will now be specified with reference to its preferred embodiment illustrated in the drawings, in which:

FIG. 1 is a schematic view of a conventional lock-driving structure installed at a fire door;

FIG. 2 is a schematic views of another conventional lock-driving structure installed at the fire door;

FIG. 3 is a schematic perspective view of a preferred embodiment of the cross bar type universal lock-driving structure in accordance with the present invention applied to a single-point lock;

FIG. 4 is a schematic exploded view of FIG. 3;

FIG. 5 demonstrates schematically the cross bar type universal lock-driving structure of FIG. 3 being applied to the single-point lock mounted on a door panel;

FIG. 6 is a schematic perspective view of the preferred embodiment of the cross bar type universal lock-driving structure in accordance with the present invention applied to a double-point lock;

FIG. 7 is a schematic exploded view of FIG. 6;

FIG. 8 demonstrates schematically the cross bar type universal lock-driving structure of FIG. 6 being applied to the double-point lock mounted on a door panel;

FIG. 9 is a schematic perspective view of the preferred embodiment of the cross bar type universal lock-driving structure in accordance with the present invention applied to a three-point lock;

FIG. 9A is a schematic cross-sectional view of FIG. 9 along line A-A;

FIG. 10 demonstrates schematically the cross bar type universal lock-driving structure of FIG. 9 being applied to the three-point lock mounted on a door panel;

FIG. 11 is a schematic perspective view of the preferred embodiment of the cross bar type universal lock-driving structure in accordance with the present invention applied to an embedded lock cartridge;

FIG. 12 demonstrates schematically the cross bar type universal lock-driving structure of FIG. 11 being applied to the embedded lock cartridge mounted in a door panel;

FIG. 13 is a schematic front view of FIG. 12;

FIG. 14 is a schematic perspective view of the preferred embodiment of the cross bar type universal lock-driving structure in accordance with the present invention applied to an embedded vertical double-point lock-driving structure; and

FIG. 15 is a schematic side view of the cross bar type universal lock-driving structure of FIG. 14 mounted on a door panel.

### DESCRIPTION OF THE PREFERRED EMBODIMENT

The invention disclosed herein is directed to a cross bar type universal lock-driving structure. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Refer now to FIG. 3 through FIG. 5; where FIG. 3 is a schematic perspective view of a preferred embodiment of the cross bar type universal lock-driving structure in accordance with the present invention applied to a single-point lock, FIG. 4 is a schematic exploded view of FIG. 3, and FIG. 5 demonstrates schematically the cross bar type universal lock-driving structure of FIG. 3 being applied to the single-point lock mounted on a door panel. As shown, the cross bar type universal lock-driving structure 1 is furnished to a single-point lock 3 in a panel-outside space SO of a door panel 2, in which the door panel 2 of this embodiment can be a fire door.

The door panel 2 includes a first door plate 21 and a second door plate 22 opposing the first door plate 21. Between the first door plate 21 and the second door plate 22, a panel-inside space SI (labeled in FIG. 15) is defined. The panel-outside space SO is the space other than the panel-inside space SI. The single-point lock 3 includes at least a driven unit 31, and the driven unit 31 further includes at least a bolt 311 to move horizontally.

The cross bar type universal lock-driving structure 1 includes a handle-end base 11, a cross bar type handle assembly 12 and a driving member 13.

The handle-end base 11 includes a basic frame 111 and a mounting frame 112. The basic frame 111, mounted onto the door panel 2, is furnished with a through hole H1. The mounting frame 112, disposed at a side of the basic frame 111 by opposing the door panel 2, has a horizontal channel T1 and a vertical channel T2. In addition, the mounting frame 112 is furnished with a base through hole H2.

The cross bar type handle assembly 12 includes a handle 121, a connection bar 122 and a handle seat 123. The handle 121, to be disposed pivotally to the handle-end base 11, is connected with the driving member 13. The connection bar 122, connected with the handle 121, is used for a user to press down the handle 121. The handle seat 123, mounted onto the mounting frame 112, is used for the handle 121 to penetrate through, such that the handle 121 can be pivotally connected on the mounting frame 112.

The driving member 13 is fixedly connected with the handle 121. Though, in this embodiment, the driving member 13 is integrated as a unique piece with the handle 121, yet, in some other embodiments of this disclosure not shown herein, the driving member 13 can be fixed to the handle 121 by a fastener, a buckling element, a glue, a solder or the like fixation means. In this disclosure, the driving member 13 and the handle 121 are fixedly connected as a solid part that is moved like a rigid body. The driving member 13 has a driving stroke D1 (labeled in FIG. 8), and is synchronously moved with the cross bar type handle assembly 12.

The driven unit 31 is located within the driving stroke D1. As the connection bar 122 is depressed down, the handle 121 would move downward in a pivotal manner as well, such that the driving member 13 would be moved along the driving stroke D1. With the driving member 13 to move along the driving stroke D1, the driven unit 31 would be pushed to displace the bolt 311 along a bolting stroke D3 (labeled in FIG. 10); i.e., in a direction to unlock. Thereupon, the door panel 2 can be pushed to open.

While the cross bar type universal lock-driving structure 1 is assembled to the single-point lock 3, a part of the driven unit 31 would move within the vertical channel T2, while another part thereof (the bolt 311) would move within the horizontal channel T1.

Then, refer now to FIG. 6 through FIG. 8; where FIG. 6 is a schematic perspective view of the preferred embodiment of the cross bar type universal lock-driving structure in accordance with the present invention applied to a double-point lock, FIG. 7 is a schematic exploded view of FIG. 6, and FIG. 8 demonstrates schematically the cross bar type universal lock-driving structure of FIG. 6 being applied to the double-point lock mounted on a door panel. As shown, the cross bar type universal lock-driving structure 1 is furnished to a double-point lock 3a, and the double-point lock 3a is mounted in the panel-outside space SO of the door panel 2. In particular, the door panel 2 can be a typical fire door.

The double-point lock 3a includes at least a driven unit 31a and a lock bar 32a, in which a part of the driven unit 31a is located within the driving stroke D1 in the vertical channel T2. Also, in this embodiment, the double-point lock 3a further includes an assembled connector 33a for connecting the driven unit 31a and the lock bar 32a.

When the connection bar 122 is pressed down, the handle 121 would move downward as well. Thereupon, the driving member 13 would move simultaneously along the driving stroke D1 to displace the driven unit 31a. The driven unit 31a would then drive the lock bar 32a to move along a vertical stroke D2 via the assembled connector 33a. On the other hand, as the connection bar 122 is pressed down, the lock bar 32a would be moved upward to put the double-point lock 3a into an unlock state, and then the door panel 2 can be pushed to open. As long as the depression upon the connection bar 122 is removed, it will resume its original position. At this time, the lock bar 32a would move downward automatically due to its own gravity. Thereby, the double-point lock 3a would be back to the lock state, and the door panel 2 is locked in position.

In addition, it is understood that the vertical single-point lock and the double-point lock 3a are largely resembled to each other. The only difference in between is that the vertical single-point lock owns the upper lock bar 32a of the double-point lock 3a but waives the lower lock bar 32a. Thus, in comparison with the double-point lock 3a, the vertical single-point lock would have only one lock point (i.e., the upper lock point). Nevertheless, to both the vertical single-point lock and the double-point lock 3a, the assembling and operation of the cross bar type universal lock-driving structure 1 are the same, and thus detail thereabout would be omitted herein.

Then, refer to FIG. 9 through FIG. 10; where FIG. 9 is a schematic perspective view of the preferred embodiment of the cross bar type universal lock-driving structure in accordance with the present invention applied to a three-point lock, FIG. 9A is a schematic cross-sectional view of FIG. 9 along line A-A, and FIG. 10 demonstrates schematically the cross bar type universal lock-driving structure of FIG. 9 being applied to the three-point lock mounted on a door panel. As shown, the cross bar type universal lock-driving structure 1 is provided to a three-point lock 3b mounted in the panel-outside space SO of the door panel 2, in which the door panel 2 can be a typical fire door.

The three-point lock 3b includes at least the aforesaid driven unit 31, a driven unit 31b, an assembled connector 32b and a lock bar 33b. The driven unit 31 includes at least the aforesaid bolt 311 defined with a bolting stroke D3. The lock bar 33b is defined with the vertical stroke D2. The assembled connector 32b connects the driven unit 31b and the lock bar 33b.

A part of the driven unit 31 and a part of the driven unit 31b are moved along the driving stroke D1 within the vertical channel T2 (labeled in FIG. 4). However, it shall be explained that the driven unit 31 and the driven unit 31b would not interfere structurally with each other. In addition, a part of the bolt 311 would move within the horizontal channel T1 (labeled in FIG. 4).

When the connection bar 122 is pressed down, the handle 121 would move downward as well. Thereupon, the driving member 13 would move simultaneously along the driving stroke D1 to displace the driven unit 31. The driven unit 31 would then displace the bolt 311 along the bolting stroke D3. In addition, as the driving member 13 moves along the driving stroke D1, the driven unit 31b would be moved simultaneously. The driven unit 31b would then drive the lock bar 33b to move along the vertical stroke D2 via the assembled connector 32b. Namely, as the connection bar 122 is pressed down, the driving member 13 would move along driving stroke D1 to drive simultaneously both the driven unit 31 and the driven unit 31b. The driven unit 31 would drive the bolt 311 to retrieve inward along the bolting stroke D3, and the driven unit 31b would drive the lock bar 33b to move upward along the vertical stroke D2. Thereupon, the three-point lock 3b would be in the unlock state, and thus the door panel 2 can be pushed to open.

In this embodiment, the driving member 13 is to push a pin 311b of the driven unit 31b, and the driven unit 31b is moved with the pin 311b. In some other embodiments of this disclosure not shown here, the pin 311b can be substituted by other element such as a fastener, a roller or any other component that can be used to move with the driven unit 31b.

As the depression upon the connection bar 122 is removed, it will gradually get back to its original position. At this time, the lock bar 33b would move downward along the vertical stroke D2 by its own gravity. Also, since the driving force upon the driven unit 31 is removed, the bolt 311 would protrude outward along the bolting stroke D3. therefore, the three-point lock 3b will resume its lock state, and the door panel 2 can't be pushed to open.

In this embodiment, since the operation of the bolt 311 is the same as that in FIG. 3, FIG. 4 or FIG. 5, thus the same number “311” is assigned. Except for the appearances, the operation of the lock bar 32b is the same as that of any of the lock bars 32 of FIG. 6 to FIG. 8. In comparison with the single-point lock 3, the double-point lock 3a and the vertical single-point lock, the three-point lock 3b has more lock points, so that, while the three-point lock 3b is in the lock state, difficulty in opening the door panel 2 is higher. In addition, also since the three-point lock 3b has more lock points, so it can still work even whenever any of the lock points (the bolt 311 or the lock bar 33b) is ineffective.

Then, refer to FIG. 11 through FIG. 13; where FIG. 11 is a schematic perspective view of the preferred embodiment of the cross bar type universal lock-driving structure in accordance with the present invention applied to an embedded lock cartridge, FIG. 12 demonstrates schematically the cross bar type universal lock-driving structure of FIG. 11 being applied to the embedded lock cartridge mounted in a door panel, and FIG. 13 is a schematic front view of FIG. 12. As shown, the cross bar type universal lock-driving structure 1 is furnished to the embedded lock cartridge 3c mounted in the panel-inside space SI of the door panel 2, while the cross bar type universal lock-driving structure 1 is deposed in the panel-outside space SO of the door panel 2. In particular, the door panel 2 is furnished with a door panel through hole H3.

The embedded lock cartridge 3c includes a driven unit 31c, a bolt 32c, a striking aperture 33c and a turning member 34c. The striking aperture 33c is adjacent to the door panel through hole H3. The turning member 34c, connected with the bolt 32c, is also adjacent to the striking aperture 33c. Here, the turning member 34c is a common part in the art. According to this disclosure, any component that can transform a first-directional linear motion into a second-directional linear motion can be the turning member 34c of this embodiment. In this embodiment, the driven unit 31c includes at least an assembled lock lever 311c.

A part of the driven unit 31c is located within the driving stroke D1 (labeled in FIG. 8) inside the vertical channel T2 (labeled in FIG. 4). In addition, a part of the assembled lock lever 311c penetrates through the through hole H1 (labeled in FIG. 4), while another part thereof penetrates through the door panel through hole H3.

As the connection bar 122 is depressed down, the handle 121 would move downward as well, and thereby the driving member 13 would be driven to displace along the driving stroke D1. As the driving member 13 moves along the driving stroke D1 (labeled in FIG. 8), the driven unit 31c would be driven to move the assembled lock lever 311c toward the striking aperture 33c to contact the turning member 34c. The turning member 34c, pushed by the assembled lock lever 311c, would then retrieve the bolt 32c. Thereupon, the embedded lock cartridge 3c can be in the unlock state, and thus the door panel 2 can be pushed to open. In particular, the assembled lock lever 311c has a hook end for pushing the turning member 34c.

In this embodiment, the through hole H1 is, but not limited to, a rectangular hole. The through hole H1 can be a round hole, an oval hole, a triangular hole, a pentagonal hole or the like. One advantage of the rectangular through hole H1 is that, while the through hole is loosely penetrated by the assembled lock lever 311c, the area and space occupied by the rectangular through hole H1 can be substantially reduced. In addition, the rectangular through hole H1 can provide further constraints to the assembled lock lever 311c, such that the assembled lock lever 311c would move toward the turning member 34c correctly, such that the contact between the assembled lock lever 311c and the turning member 34c can be assured.

Finally, refer to FIG. 14 and FIG. 15; where FIG. 14 is a schematic perspective view of the preferred embodiment of the cross bar type universal lock-driving structure in accordance with the present invention applied to an embedded vertical double-point lock-driving structure, and FIG. 15 is a schematic side view of the cross bar type universal lock-driving structure of FIG. 14 mounted on a door panel. As shown, the cross bar type universal lock-driving structure 1 (labeled in FIG. 4), furnished to the embedded vertical double-point lock-driving structure 3d, is mounted in the panel-outside space SO (labeled in FIGS.) of the door panel 2, while the embedded vertical double-point lock-driving structure 3d is installed into the panel-inside space SI.

The embedded vertical double-point lock-driving structure 3d includes at least a driven unit 31d, an assembled connector 32d, and a lock bar 33d. The driven unit 31d, including an assembled lock lever 311d, is located within the driving stroke D1 in the vertical channel T2 (labeled in FIG. 4), in which a part of the assembled lock lever 311d penetrates through the through hole H1.

When the connection bar 122 is depressed down, the handle 121 is moved downward as well, such that the driving member 13 would be driven to displace along the driving stroke D1. As the driving member 13 moves along the driving stroke D1, the driven unit 31d would move the assembled lock lever 311d down, and thus the embedded vertical double-point lock-driving structure 3d would move upward to enter the unlock state. Then, at this time, the door panel 2 can be pushed to open.

It shall be explained that, in this disclosure, the major feature is the entire internal structure of the cross bar type universal lock-driving structure 1, not the housing, and thus the housing is not sketched in all the figures. Nevertheless, practically, the cross bar type universal lock-driving structure 1 does include a housing for a comfortable appearance and also for preventing from exposing the internal handle-end base 11, cross bar type handle assembly 12 and driving member 13. However, the housing will not shield completely the horizontal channel T1 and the vertical channel T2.

In summary, since the cross bar type universal lock-driving structure of this disclosure furnished with both the horizontal channel and the vertical channel includes the handle-end base, the cross bar type handle assembly and the driving member, and also since the handle-end base is furnished with the through hole, thus the cross bar type universal lock-driving structure provided by this invention can be universally applied to the single-point lock, the double-point lock, the three-point the lock, the vertical single-point lock, the embedded lock cartridge and the embedded vertical double-point lock-driving structure. In comparison to the prior art whose lock or lock cartridge needs specific lock-driving structure, the cross bar type universal lock-driving structure of this invention can be directly and commonly used to fit different locks and lock cartridges. Thereupon, the relative manufacturing cost can be significantly reduced. In addition, while a replacement or maintenance of the lock is needed, the replacement process and complexity would be remarkably reduced due to the universality provided by the cross bar type universal lock-driving structure of this invention,

While the present invention has been particularly shown and described with reference to a preferred embodiment, it will be understood by those skilled in the art that various changes in form and detail may be without departing from the spirit and scope of the present invention.

What is claimed is:

1. A cross bar type universal lock-driving structure, to be mounted in a panel-outside space of a door panel, having a horizontal channel and a vertical channel, applied to one of a single-point lock, a double-point lock, a three-point lock, a vertical single-point lock, an embedded lock cartridge and an embedded vertical double-point lock-driving structure, comprising:
a handle-end base, deposed in the panel-outside space of the door panel, furnished with a through hole;
a cross bar type handle assembly, pivotally connected with the handle-end base; and
a driving member, connected fixedly with the cross bar type handle assembly, being to contact a driven unit of one of the single-point lock, the double-point lock, the three-point lock, the vertical single-point lock, the embedded lock cartridge and the embedded vertical double-point lock-driving structure, driving the driven unit while the cross bar type handle assembly is depressed downward;
wherein the horizontal channel allows at least a part of the driven unit of the single-point lock to move thereinside, the vertical channel allows at least another part of the driven unit of one of the double-point lock, the three-point lock and the vertical single-point lock to move thereinside, and the through hole allows at least a further part of the driven unit of one of the embedded lock cartridge and the embedded vertical double-point lock-driving structure to move therethrough.

2. The cross bar type universal lock-driving structure of claim 1, wherein the driving member is integrated with the cross bar type handle assembly as a unique piece.

3. The cross bar type universal lock-driving structure of claim 1, wherein the cross bar type handle assembly includes:
a handle, disposed pivotally to the handle-end base, connected with the driving member; and
a connection bar, connected with the handle.

4. The cross bar type universal lock-driving structure of claim 3, wherein the cross bar type handle assembly further includes a handle seat, the handle seat is connected with the handle-end base, and the handle seat is used for the handle to penetrate through so as to have the handle to be pivotally connected with the handle-end base.

5. The cross bar type universal lock-driving structure of claim 1, wherein the handle-end base includes:
a basic frame, mounted onto the door panel, furnished with the through hole; and
a mounting frame, disposed at a side of the basic frame by opposing the door panel, having the horizontal channel and the vertical channel.

6. The cross bar type universal lock-driving structure of claim 5, wherein the mounting frame is further furnished with a base through hole for the driving member to penetrate through.

7. The cross bar type universal lock-driving structure of claim 1, wherein the through hole is a rectangular hole.

8. The cross bar type universal lock-driving structure of claim 1, wherein the driving member has a driving stroke, and the driven unit is located within the driving stroke.
